(19) United States
(12) Patent Application Publication
(10) Pub. No.: US 2025/0156151 A1
(43) Pub. Date: May 15, 2025

(54) HARDWARE ACCELERATION CIRCUIT, DATA PROCESSING ACCELERATION METHOD, CHIP, AND ACCELERATOR

(71) Applicant: Guangzhou Xiaopeng Autopilot Technology Co., Ltd., Guangzhou (CN)

(72) Inventors: Yuanxiang Guo, Guangzhou (CN); Jiang Jiang, Guangzhou (CN); Weijun Zhang, Guangzhou (CN); Hengchang Xiong, Guangzhou (CN); Yu Hu, Guangzhou (CN); Chia-Lin Lu, Guangzhou (CN)

(21) Appl. No.: 18/389,361

(22) Filed: Nov. 14, 2023

(51) Int. Cl. G06F 7/556; G06F 1/03; G06F 5/01; G06F 7/485

(52) U.S. Cl. CPC G06F 7/556; G06F 1/0307; G06F 5/012; G06F 7/485

(57) ABSTRACT

A hardware acceleration circuit, a data processing acceleration method, a chip, and an accelerator are provided. The hardware acceleration circuit includes: an exponential function module, configured to obtain exponential function values of a plurality of data elements in a data set; an adder, configured to obtain an addition operation result of the exponential function values; a first processing circuit, configured to perform preset processing on the addition operation result, to process the addition operation result into at least first data and second data; a second processing circuit, configured to perform preset processing on at least the first data and the second data, to obtain a reciprocal of the addition operation result; and a third processing circuit, configured to perform preset processing on an exponential function value of an i^{th} data element in the data elements and the reciprocal, to obtain a specific function value of the i^{th} data element.

### FIELD OF THE INVENTION

This application relates to the field of artificial intelligence technologies, and in particular, to a hardware acceleration circuit, data processing acceleration method, a chip, and an accelerator.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

A non-linear function introduces non-linear characteristics into an artificial neural network, which plays a very important role in complex scenarios of learning and understanding by the artificial neural network. The non-linear function includes but is not limited to a Softmax (Softmax) function, a sigmoid function, and the like.

For example, the Softmax function is widely applied to deep learning. In the related art, a function value of the Softmax function may be calculated by using a general-purpose calculation unit, for example, a central processing unit (CPU) or a graphics processing unit (GPU). However, when a neural network processing process is executed by, for example, a hardware circuit such as a deep learning accelerator (DLA for short), a neural network processing unit (NPU for short), or the like, if a Softmax function layer is located on a network intermediate layer of a neural network, overheads of job migration between the DLA/NPU and the CPU/GPU may be caused, causing low efficiency of a solution in which a non-linear function value is determined by using the CPU/GPU, and resulting in increased system bandwidth and higher power consumption.

### SUMMARY OF THE INVENTION

To resolve or partially resolve the problem existing in the related technology, this application provides a hardware acceleration circuit, a data processing acceleration method, a chip, and an accelerator, to reduce an amount of calculation for data processing, thereby accelerating a speed of obtaining a non-linear function value.

An aspect of this application provides a hardware acceleration circuit, the hardware acceleration circuit including:
an exponential function module, configured to obtain a plurality of exponential function values of a plurality of data elements in a data set;
an adder, configured to obtain an addition operation result of the plurality of exponential function values;
a first processing circuit, configured to perform preset processing on the addition operation result, to process the addition operation result into at least first data and second data, where a length of the addition operation result is N1 bits, a length of the first data is N2 bits, a length of the second data is N3 bits, and both N2 and N3 are less than N1;
a second processing circuit, configured to perform preset processing on at least the first data and the second data, to obtain a reciprocal of the addition operation result; and
a third processing circuit, configured to perform preset processing on an exponential function value of an i^{th} data element in the plurality of data elements and the reciprocal, to obtain a specific function value of the i^{th} data element.

Another aspect of this application provides an artificial intelligence chip, including the hardware acceleration circuit described above.

Still another aspect of this application provides a data processing acceleration method, applied to an artificial intelligence accelerator, the method including:
obtaining a plurality of exponential function values of a plurality of data elements in a data set;
obtaining an addition operation result of the plurality of exponential function values;
obtaining a reciprocal of the addition operation result; and
obtaining a specific function value of an i^{th} data element based on an exponential function value of the i^{th} data element in the plurality of data elements and the reciprocal, where
the obtaining a reciprocal of the addition operation result includes:
processing the addition operation result into at least first data and second data; and
obtaining the reciprocal of the addition operation result according to at least the first data and the second data, where
a length of the addition operation result is N1 bits, a length of the first data is N2 bits, a length of the second data is N3 bits, and both N2 and N3 are less than N1.

Yet another aspect of this application provides an artificial intelligence accelerator, including:
a processor; and
a memory, storing executable code, where the executable code, when executed by the processor, causes the processor to perform the method described above.

The technical solutions provided in this application may have the following advantageous effects:

In the technical solutions of the embodiments of this application, an addition operation result of exponential function values of data elements is processed into at least first data and second data whose length is lower than the addition operation result, and preset processing is performed on at least the first data and the second data to obtain a reciprocal of the addition operation result. In this case, a bit width of the processed data is reduced, so that an amount of calculation for data processing is reduced, thereby accelerating a speed of obtaining a non-linear function value.

It is to be understood that the foregoing general description and the following detailed description are merely for illustration and explanation purposes and are not intended to limit this application.

### BRIEF DESCRIPTION OF THE DRAWINGS

Through a more detailed description of exemplary implementations of this application in combination with the accompanying drawings, the above and other objectives, features and advantages of this application are more obvious. In the exemplary implementations of this application, same reference numerals generally represent same components.

FIG. 1 is a schematic structural diagram of a neural network according to an embodiment of this application;

FIG. 2 is a schematic structural diagram of a neural network for classification according to an embodiment of this application;

FIG. 3 is a structural block diagram of a hardware acceleration circuit according to an embodiment of this application;

FIG. 4A is a structural block diagram of a hardware acceleration circuit according to another embodiment of this application;

FIG. 4B is a schematic structural diagram of a basic lookup table circuit unit according to an embodiment of this application;

FIG. 5 is a structural block diagram of a hardware acceleration circuit according to another embodiment of this application;

FIG. 6 is a structural block diagram of a hardware acceleration circuit according to another embodiment of this application.

FIG. 7 to FIG. 9 are schematic flowcharts of a data processing acceleration method according to some embodiments of this application; and

FIG. 10 is a structural block diagram of an artificial intelligence accelerator according to an embodiment of this application.

### DETAILED DESCRIPTION OF THE INVENTION

The following describes in detail implementations of this application with reference to the accompanying drawings. Although the accompanying drawings show the implementations of this application, it should be understood that this application may be implemented in various manners and is not limited by the implementations described herein. On the contrary, the implementations are provided to make this application more thorough and complete, and the scope of this application can be fully conveyed to a person skilled in the art.

The terms used in this application are for the purpose of describing specific embodiments only and are not intended to limit this application. The singular forms of “a” and “the” used in this application and the appended claims are intended to include the plural forms as well, unless the context clearly indicates otherwise. It should be further understood that the term “and/or” used herein indicates and includes any or all possible combinations of one or more associated listed items.

It should be understood that although the terms such as “first,” “second,” and “third,” may be used in this application to describe various information, the information should not be limited to these terms. These terms are merely used to distinguish between information of the same type. For example, without departing from the scope of this application, first information may also be referred to as second information, and similarly, second information may also be referred to as first information. Therefore, features defining “first” and “second” may explicitly or implicitly include one or more such features. In the descriptions of this application, “a plurality of” means two or more, unless otherwise definitely and specifically limited.

A calculation procedure of a non-linear function possibly relates to an operation procedure of an exponential function and/or a reciprocal. For example, an operation procedure of a Softmax function may relate to operation procedures of an exponential (exp) and a reciprocal of a sum of exponentials (1/sum_of_exp).

A solution for accelerating data processing is provided in the embodiments of this application, an addition operation result of exponential function values of data elements is processed into at least first data and second data whose length (namely, bit width) is lower than the addition operation result, and preset processing is performed on at least the first data and the second data to obtain a reciprocal of the addition operation result. In this case, a bit width of the processed data is reduced, so that an amount of calculation for data processing is reduced, thereby accelerating a speed of obtaining a non-linear function value.

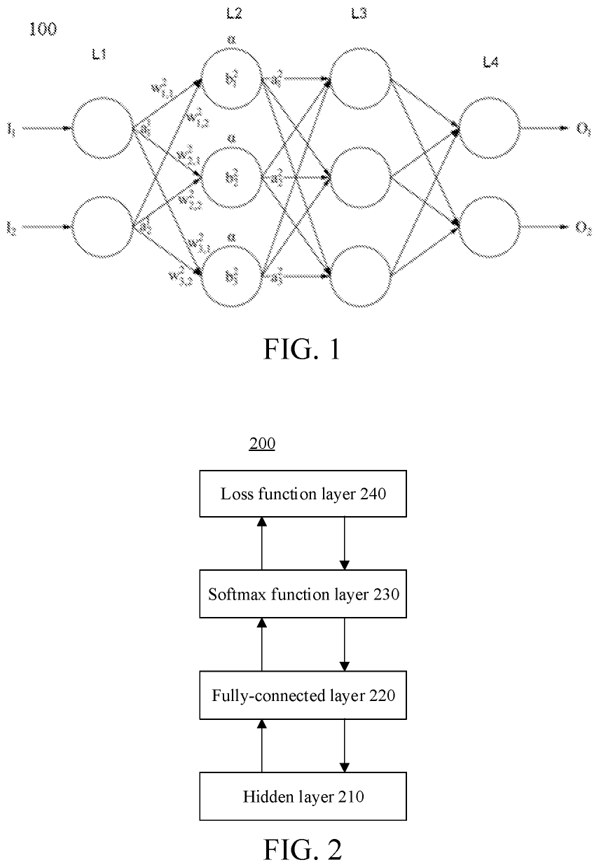

FIG. 1 is a schematic structural diagram of a neural network according to an embodiment of this application.

FIG. 1 shows a topology structure of a neural network 100, including an input layer, a hidden layer, and an output layer. The neural network 100 can execute a calculation or an operation based on data elements I₁ and I₂ received by the input layer, and generate output data O₁ and O₂ based on a result of executing the calculation.

For example, the neural network 100 may be a deep neural network (deep neural network, DNN for short) including one or more hidden layers. The neural network 100 in FIG. 1 includes an input layer L1, two hidden layers L2 and L3, and an output layer L4. The DNN includes but is not limited to a convolutional neural network (convolutional neural network, CNN for short) and a recurrent neural network (recurrent neural network, RNN for short).

It should be noted that the four layers shown in FIG. 1 are only intended for ease of understanding technical solutions of this application, but cannot be understood as a limitation on this application. For example, the neural network may include more or fewer hidden layers.

Nodes in different layers of the neural network 100 may be connected to each other, to perform data transmission. For example, a node may receive data from another node to execute a calculation on the received data, and output a calculation result to a node in the another layer.

Each node may determine output data of the node based on output data received from a node in a previous layer and a weight. For example, in FIG. 1, W_{1,1}² represents a weight between a first node in a first layer and a first node in a second layer. α₁¹ represents output data of the first node in the first layer. b₁² represents an offset value of the first node in the second layer, and then output data of the first node in the second layer may be represented as: b₁². Manners of calculating output data of other nodes are similar, and details are not described herein again.

In some embodiments, an activation function layer such as a Softmax (Softmax) function layer is configured in the neural network, and the Softmax function layer may convert a result value about each class to a probability value.

In some embodiments, a loss function layer is configured in the neural network after the Softmax function layer, and the loss function layer can calculate a loss as a target function for training or learning.

It may be understood that, the neural network may process, in response to to-be-processed data, the to-be-processed data, to obtain a recognition result. The to-be-processed data may include, for example, at least one of voice data, text data, and image data.

A typical type of neural network is a neural network for classification. The neural network for classification may determine a class of a data element by calculating the data element and a probability corresponding to each class.

FIG. 2 is a schematic structural diagram of a neural network for classification according to an embodiment of this application.

Referring to FIG. 2, a neural network 200 for classification of this embodiment may include a hidden layer 210, a fully-connected layer (Fully-Connected Layer, FC layer for short) 220, a Softmax function layer 230, and a loss function layer 240.

As shown in FIG. 2, the neural network 200 performs, in response to to-be-processed data, a calculation sequentially in an order of the hidden layer 210 and the FC layer 220, the FC layer 220 outputs a calculation result s, and the result corresponds to a classification probability of a data element. The FC layer 220 may include a plurality of nodes corresponding to a plurality of classes respectively, and each node outputs a result value corresponding to a probability that a data element is classified as a corresponding class. For example, referring to FIG. 1 together, the FC layer 220 corresponds to the output layer L4 in FIG. 1, and has two nodes corresponding to two classes (a first class and a second class), where an output value of one node may be a result value representing a probability that a data element is classified as the first class, and an output value of the other node may be a result value representing a probability that a data element is classified as the second class. The FC layer 220 outputs the calculation result s to the Softmax function layer 230, and the Softmax function layer 230 converts the calculation result s to a probability value y, and may further perform normalization processing on the probability value y.

The Softmax function layer 230 outputs the probability value y to the loss function layer 240, and the loss function layer 240 may calculate a cross-entropy loss (cross-entropy loss) L of the result s based on the probability value y.

In a back-propagation learning procedure, the Softmax function layer 230 calculates a gradient

$$\frac{\partial L}{\partial s}$$

of the cross-entropy loss L. Then, the FC layer 220 executes learning processing based on the gradient of the cross-entropy loss L. For example, a weight of the FC layer 220 may be updated according to a gradient descent algorithm. Further, subsequent learning processing may be executed in the hidden layer 210.

The neural network 200 may be implemented using software, or implemented using a hardware circuit, or implemented using a combination of software and hardware. For example, in a case of being implemented using a hardware circuit, the hidden layer 210, the FC layer 220, the Softmax function layer 230, and the loss function layer 240 are each implemented by a hardware circuit, and may be implemented by being integrated into an artificial intelligence chip or distributed in a plurality of chips. Through such a configuration, data migration between another layer of the neural network and a processor such as a CPU/GPU when the Softmax function layer 230 is implemented by the CPU/GPU is avoided, which can increase data processing efficiency of the neural network, reduce data processing delay and power consumption, and avoid an increase in occupied bandwidth.

The following describes in detail the technical solutions in the embodiments of this application with reference to the accompanying drawings.

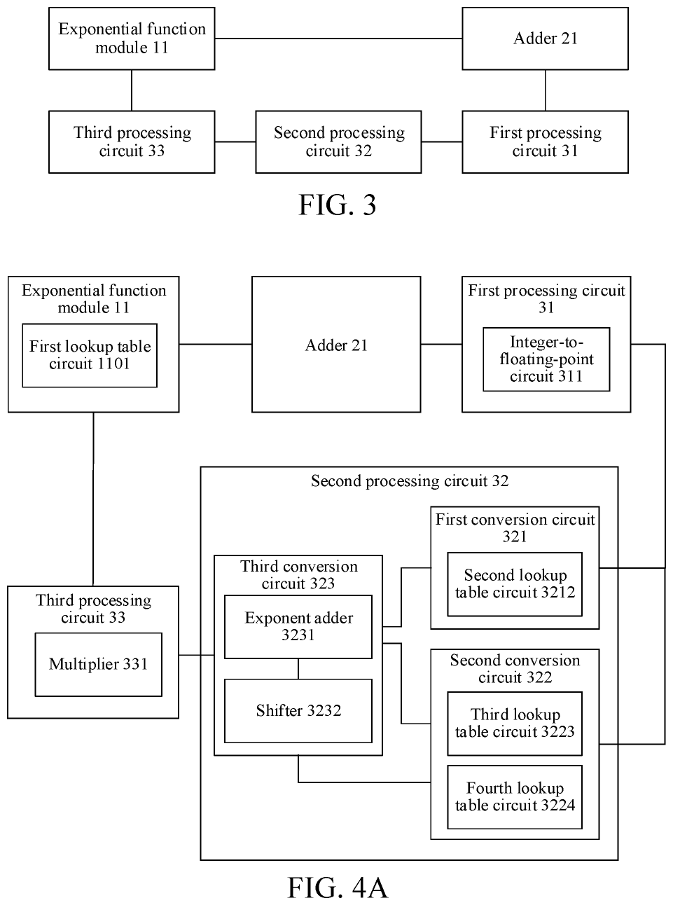

FIG. 3 is a structural block diagram of a hardware acceleration circuit according to an embodiment of this application. In this application, the hardware acceleration circuit may be, for example, configured to, but not limited to, implement the Softmax function layer 230 in the foregoing neural network 200, and the hardware acceleration circuit may be, for example, but not limited to, a circuit component in a CPLD (Complex Programmable logic device, complex programmable logic device) chip, an FPGA (Field Programmable Gate Array, field programmable gate array) chip, a dedicated chip, or the like.

For ease of understanding this application, the Softmax function is described as follows: Assuming that there is an array X, a formula of calculating a Softmax function value of an i^{th} element xᵢ may be shown as formula (1).

$${σ ( x )}_{i} = \frac{{e}^{{x}_{i}}}{\sum {ke}^{{x}_{k}}} = \frac{{{e}^{( {x}_{i}}}^{- c )}}{\sum {ke}^{( {x}_{k} - c )}} \qquad formula ( 1 )$$

In the formula (1), σ(x)i represents a Softmax function value of an i^{th} element xᵢ, e is a natural constant, xᵢ represents an i^{th} element of the array X, c represents a maximum element in the array X, and Σₖd^{x}^{ₖ} represents an addition operation result of exponential function values of at least some elements in the array X.

Referring to FIG. 3, a hardware acceleration circuit includes an exponential function module 11, an adder 21, a first processing circuit 31, a second processing circuit 32, and a third processing circuit 33.

The exponential function module 11 is configured to obtain a plurality of exponential function values of a plurality of data elements in a data set.

In an embodiment, the exponential function module 11 may respond to an index value of each data element in the data set, output an exponential function value corresponding to each data element based on the first lookup table, and output respective exponential function values of all data elements in the data set.

The adder 21 is configured to obtain an addition operation result of the plurality of exponential function values.

In an embodiment, the adder 21 may perform an addition operation on the respective exponential function values of all data elements according to the respective exponential function values of all data elements inputted by the exponential function module 11, and output an addition operation result of the exponential function values of all data elements in the data set.

It may be understood that, an addition operation result of exponential function values may be a result obtained by performing an addition operation directly on the exponential function values, or may be a result obtained by performing an addition operation on the exponential function values on which specific transformation is performed. For a situation of performing specific transformation, corresponding inverse transformation may be performed on a subsequently obtained data processing result based on a transformation type, or inverse transformation processing is not additionally performed. Similarly, various types of processing performed on other data should also be understood as including the foregoing two situations in a broad sense, but should not be limited to only processing performed on the data itself. Other embodiments are similar, and details are not described again below.

The first processing circuit 31 is configured to perform preset processing on the addition operation result, to process the addition operation result into at least first data and second data.

In an embodiment, a length of the addition operation result outputted by the adder 21 is N1 bits, and the first processing circuit 31 may perform data conversion on the addition operation result whose length is N1 bits, to output first data and second data, where a length of the first data is N2 bits, a length of the second data is N3 bits, and both N2 and N3 are less than N1.

The second processing circuit 32 is configured to perform preset processing on at least the first data and the second data, to obtain a reciprocal of the addition operation result.

In an embodiment, the second processing circuit 32 performs preset processing on the first data and the second data, and in response to the first data and the second data, outputs, based on a corresponding lookup table, a table lookup result corresponding to the first data and the second data, so that the reciprocal of the addition operation result is obtained by performing a data operation on the table lookup result corresponding to the first data and the second data.

The third processing circuit 33 is configured to perform preset processing on an exponential function value of an i^{th} data element in the plurality of data elements and the reciprocal, to obtain a specific function value of the i^{th} data element.

In an embodiment, the third processing circuit 33 may perform a multiplication operation on the exponential function value of the i^{th} data element in the plurality of data elements and the reciprocal of the addition operation result, to output a Softmax function value of the i^{th} data element.

In this embodiment, an addition operation result of exponential function values of data elements is processed into at least first data and second data whose length (namely, bit width) is lower than the addition operation result, and preset processing is performed on at least the first data and the second data to obtain a reciprocal of the addition operation result. In this case, a bit width of the processed data is reduced, so that an amount of calculation for data processing is reduced, thereby accelerating a speed of obtaining a non-linear function value.

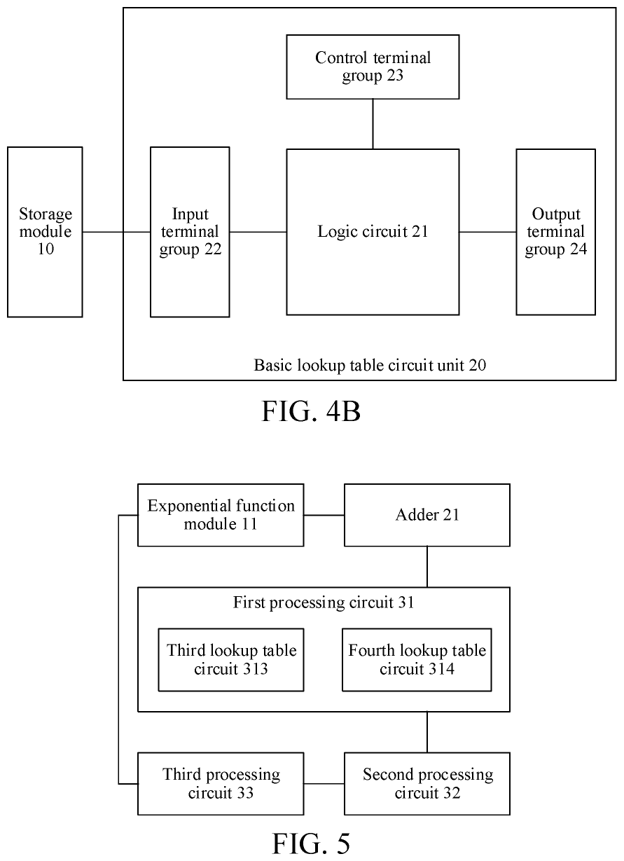

FIG. 4A is a structural block diagram of a hardware acceleration circuit according to another embodiment of this application.

Referring to FIG. 4A, a hardware acceleration circuit includes an exponential function module 11, an adder 21, a first processing circuit 31, a second processing circuit 32, and a third processing circuit 33.

The exponential function module 11 includes a first lookup table circuit 1101. The first lookup table circuit 1101 is configured to obtain, based on a first lookup table, the plurality of exponential function values corresponding to the plurality of data elements in the data set.

The first lookup table circuit 1101 may output an exponential function value corresponding to each data element based on the first lookup table, and output respective N4-bit exponential function values of all data elements in the data set.

The adder 21 is configured to obtain an addition operation result of the plurality of exponential function values.

In an embodiment, the adder 21 may perform an addition operation on the respective N4-bit exponential function values of all data elements according to the respective N4-bit exponential function values of all data elements inputted by the exponential function module 11, and output an addition operation result of the exponential function values of all data elements in the data set, where the addition operation result may be an N1-bit fixed-point integer.

The first processing circuit 31 includes an integer-to-floating-point circuit 311. The integer-to-floating-point circuit 311 is configured to convert the addition operation result from the integer into a floating-point number indicated by using first exponent data and first mantissa data.

In a specific implementation, the integer-to-floating-point circuit 311 includes: a leading zero count circuit or a leading 1 detection circuit, a shifter, and a subtractor.

The leading zero count circuit is configured to output a leading zero count in the addition operation result. The leading zero count is a quantity of 0s appearing during scanning starting from the most significant bit of binary data to the first 1. The leading 1 detection circuit is configured to output a leading 1 count in the addition operation result. The leading 1 is the first 1 scanned starting from the most significant bit of the binary data.

The shifter is configured to output the first mantissa data in the addition operation result according to the leading zero count or the leading 1 count. In a specific implementation, the shifter uses the leading zero count as a shifting quantity, and shifts the addition operation result to the left by the shifting quantity, to output shifted data whose bit width is N3 bits, that is, captures data of N3 consecutive bits from the addition operation result in a direction starting from a next place of the leading 1 to the least significant, to serve as the first mantissa data of the addition operation result.

The subtractor is configured to subtract the leading zero count or the leading 1 count from a preset value, to output the first exponent data of the addition operation result.

The second processing circuit 32 includes a first conversion circuit 321, a second conversion circuit 322, and a third conversion circuit 323.

The first conversion circuit 321 is configured to convert the first exponent data into a negative number.

In an embodiment, the first conversion circuit 321 includes a second lookup table circuit 3212. The second lookup table circuit 3212 is configured to output, based on a second lookup table, the negative number corresponding to the first exponent data.

The second conversion circuit 322 is configured to convert, according to the first mantissa data, a decimal part of the floating-point number represented by using the first exponent data and the first mantissa data into another floating-point number indicated by using second exponent data and second mantissa data.

In an embodiment, the second conversion circuit 322 includes a third lookup table circuit 3223 and a fourth lookup table circuit 3224. The third lookup table circuit 3223 is configured to obtain, based on a third lookup table, second exponent data exp2 corresponding to the first mantissa data. The fourth lookup table circuit 3224 is configured to obtain, based on a fourth lookup table, second mantissa data frac1 corresponding to the first mantissa data.

The third conversion circuit 323 includes an exponent adder 3231 and a shifter 3232. The exponent adder 3231 is configured to obtain a sum of the negative number of the first exponent data and the second exponent data. The shifter 3232 is configured to perform shift processing on the second mantissa data by using the sum as a shift parameter, to obtain the reciprocal of the addition operation result.

It may be understood that shift processing on the second mantissa data may be performed after necessary conversion or processing (for example, 1's complement processing mentioned later) is performed on the second mantissa data.

The third processing circuit 33 includes a multiplier 331, configured to perform a multiplication operation on the exponential function value that is of the i^{th} data element in the plurality of data elements and that is outputted by the exponential function module 11 and the reciprocal of the addition operation result of the plurality of exponential function values outputted by the second processing circuit 32, to output a Softmax function value of the i^{th} data element.

It may be understood that, in some other embodiments, some or all of table lookup manners in the foregoing process may also be replaced by software calculation by a processor (such as a CPU or GPU).

Descriptions are given in detail below with reference to formulas.

In an embodiment, a floating point of an addition operation result fp0 is expressed as follows:

$$fp 0 \approx {2}^{exp 0} * ( 1 + \frac{frac 0}{{2}^{N 3}} ) ,$$

and a reciprocal may be represented as:

$$\begin{matrix}\frac{1}{fp 0} = \frac{1}{{2}^{exp 0} * ( 1 + \frac{frac 0}{{2}^{N 3}} )} \\ = \frac{1}{{2}^{exp 0}} * \frac{1}{1 + \frac{frac 0}{{2}^{N 3}}} \\ = {2}^{- exp 0} * \frac{1}{1 + \frac{frac 0}{{2}^{N 3}}}\end{matrix}$$

$$assuming that$$

$$fp 1 = \frac{1}{1 + \frac{frac 0}{{2}^{N 3}}} \approx {2}^{exp 1} * ( 1 + \frac{frac 1}{{2}^{N 3}} ) ,$$

$$then$$

$$\begin{matrix}\frac{1}{fp 0} \approx {2}^{- exp 0} * fp 1 \\ \approx {2}^{- exp 0} * {2}^{exp 1} * ( 1 + \frac{frac 1}{{2}^{N 3}} ) \\ = {2}^{- exp 0 + exp 1} * ( 1 + \frac{frac 1}{{2}^{N 3}} ) ;\end{matrix}$$

In combination with the formula, the integer-to-floating-point circuit 311 converts an addition operation result fp0 in fixed-point integer format into a floating-point number represented by using first exponent data exp0 and first mantissa data frac0. The second lookup table circuit 3212 outputs, based on the second lookup table, a negative number-exp0 corresponding to the first exponent data exp0. The third lookup table circuit 3223 of the second conversion circuit 322 outputs, based on the third lookup table, second exponent data exp1 corresponding to the first mantissa data frac0. The fourth lookup table circuit 3224 of the second conversion circuit 322 outputs, based on the fourth lookup table, second mantissa data frac1 corresponding to the first mantissa data frac0.

As shown in the foregoing formula, a reciprocal

$$\frac{1}{fp 0}$$

of the addition operation result fp0 may be obtained by multiplying 2^{-exp 0+exp 1} and

$$( 1 + \frac{frac 1}{{2}^{N 3}} ) .$$

In a specific implementation, after 1 is complemented to

$$\frac{frac 1}{{2}^{N 3}} ,$$

a result of −exp0+exp1 is used as a shift parameter and is obtained by performing shift processing on

$$( 1 + \frac{frac 1}{{2}^{N 3}} ) .$$

It may be understood that the conversion of fp0 and the conversion of frac0 in the foregoing formula are approximate conversions, and an error caused by the conversion has a negligible impact on calculation precision during application.

The third processing circuit 33 is configured to perform a multiplication operation on an N4-bit exponential function value of the i^{th} data element in the plurality of data elements and an N5-bit reciprocal of the addition operation result, to obtain an N6-bit multiplication operation result of the i^{th} data element. Further, the N6-bit multiplication operation result may be converted, for example, converted into an N7-bit result with a lower bit width. The converted result may be used as the Softmax function value of the i^{th} data element outputted by the hardware acceleration circuit. It may be understood that, converting the bit width of the multiplication operation result from N6 bits into N7 bits may be implemented by perform saturation (saturate) or integer conversion. The integer conversion includes, for example, rounding (round), ceiling, flooring, and rounding to zero.

In an embodiment, a length of the first exponent data and the second exponent data may be N2 bits, and a length of the first mantissa data and the second mantissa data may be N3 bits. Values of N2 and N3 may be in a range of [1, 32], and may be in a range of [8, 12] in some specific embodiments. The values of N2 and N3 may be the same or different.

In this embodiment, the first lookup table, the second lookup table, the third lookup table, and the fourth lookup table may be stored in a storage module, and the storage module may be, for example, a RAM (random access memory), a ROM (read-only memory), a FLASH, or the like.

In an embodiment, the hardware acceleration circuit includes at least two lookup table circuits in the first lookup table circuit to the fourth lookup table circuit, that is, including two, or three, or all of the lookup table circuits, and the at least two lookup table circuits each have a respective basic lookup table circuit unit.

Referring to FIG. 4B, in an embodiment, a basic lookup table circuit unit 20 includes an input terminal group 22, a control terminal group 23, an output terminal group 24, and a logic circuit 21. The input terminal group 22 is connected to a memory 10 and inputs data of a lookup table to the logic circuit 21. The logic circuit 21 selects, through an index value (also referred to as an address) input from the control terminal group 23, a value corresponding to the index value from the lookup table, and outputs the value from the output terminal group 24. The logic circuit 21 may be, for example, a logic gate circuit or a logic switch circuit. It may be understood that, in this application, a terminal group refers to a group of connection ends, including one or more connection ends. In a case that the control terminal group 23 has A control ends and the output terminal group 24 has B output ends, the basic lookup table circuit unit 20 is referred to as A-input and B-output.

The basic lookup table circuit unit 20 may perform table lookup and output based on the stored lookup table. Taking a first lookup table as an example, the lookup table is also A-input and B-output, a data element of the lookup table is an index value whose bit width is A bits, and output data is an exponential function value whose bit width is B bits. The first lookup table in the storage area stores a true value of the exponential function value, and the basic lookup table circuit unit is configured to implement a mapping relationship between the index value and the true value of the exponential function value.

By using an example in which the first lookup table circuit to the fourth lookup table circuit of the hardware acceleration circuit each have a respective basic lookup table circuit unit, the storage module includes a first storage area to a fourth storage area, and the first lookup table to the fourth lookup table are respectively stored in the first storage area to the fourth storage area. The first lookup table circuit includes a first basic lookup table circuit unit, the second lookup table circuit includes a second basic lookup table circuit unit, the third lookup table circuit includes a third basic lookup table circuit unit, and the fourth lookup table circuit includes a fourth Basic lookup table circuit unit. The first basic lookup table circuit unit is connected to the first storage area and is configured to output, in response to an index value of the i^{th} data element, a corresponding exponential function value stored in the first lookup table in the first storage area. The second basic lookup table circuit unit is connected to the second storage area and is configured to output, in response to an index value of the first exponent data, a corresponding negative number stored in the second lookup table in the second storage area. The third basic lookup table circuit unit is connected to the third storage area and is configured to output, in response to an index value of the first mantissa data, corresponding second exponent data stored in the third lookup table in the third storage area. The fourth basic lookup table circuit unit is connected to the fourth storage area and is configured to output, in response to an index value of the first mantissa data, corresponding second mantissa data stored in the fourth lookup table in the fourth storage area. In another embodiment, the hardware acceleration circuit includes at least two lookup table circuits in the first lookup table circuit to the fourth lookup table circuit, and some lookup table circuits share a basic lookup table circuit unit. By reusing the basic lookup table circuit unit, required basic lookup table circuit units may be reduced, so that the area and costs of the hardware acceleration circuit can be effectively reduced.

By using an example in which the first lookup table circuit and the second lookup table circuit of the hardware acceleration circuit share a basic lookup table circuit unit (for example, referred to as a first basic lookup table circuit unit), the first basic lookup table circuit unit includes a first input terminal group, a first control terminal group, a first output terminal group, and a first logic gate circuit. The first input terminal group is connected to the storage module. The first logic gate circuit is configured to output, in response to an index value of the i^{th} data element inputted from the first control terminal group and based on the first lookup table, the exponential function value corresponding to the i^{th} data element from the first output terminal group in a first period of time, and output, in response to the index value of the first exponent data inputted from the first control terminal group and based on the second lookup table, a negative number corresponding to the first exponent data from the first output terminal group in a second period of time after the first period of time.

It may be understood that, in a specific implementation of this embodiment, the storage module includes a first storage area, and the first lookup table and the second lookup table are stored in the first storage area in a time-sharing manner. Because only one storage area needs to be configured to store either of the first lookup table and the second lookup table in a time-sharing manner, a storage space occupied by the lookup tables is effectively reduced, and hardware costs can be reduced. In another specific implementation, the storage module includes a first storage area and a second storage area, the first lookup table is stored in the first storage area, and the second lookup table is stored in the second storage area.

It may be understood that, in this application, an index value of data may be the data itself, or may be obtained by performing specific conversion on the data.

In this embodiment, the exponential function values of the data elements are obtained in a table lookup manner through a hardware lookup table circuit, and an addition operation result of the exponential function values is obtained through an adder. The addition operation result is converted into a plurality of data parts with lower bit widths, and then a division operation on the addition operation result is implemented through table lookup and subsequent addition and multiplication processing, to obtain a corresponding reciprocal of the addition operation result. Complex exponential operations and reciprocal operations are avoided, which can increase a data processing speed in a non-linear function calculation procedure and obtain a non-linear function value more quickly. On the other hand, excessively large hardware circuit area and excessively high costs generated for implementing exponential operations and reciprocal operations are avoided.

Further, through three lookup tables of lower bit-width data, that is, after the addition operation result is converted from an integer to a floating-point number represented by using the first exponent data and the first mantissa data with both reduced bit widths, the negative number of the first exponent data is obtained by using the first lookup table, and the second exponent data and the second mantissa data are obtained by using the second lookup table and the third lookup table, which can significantly reduce the dependence of the lookup table on large storage space and reduce the area and costs of the lookup table logic circuit, and shortens table lookup time, thereby accelerating a data processing speed.

For example, if the addition operation result is a 16-bit integer, a lookup table required for direct table lookup includes 2\hat{ }16 (that is, 65536) entries, which requires large storage space to store data and results in excessively high costs of the lookup table logic circuit. On the other hand, it takes 65536 cycles to complete a single table lookup result, and processing duration is excessively long. In this application, for example, the 16-bit addition operation result may be converted from an integer into a floating-point number represented by using the first exponent data whose bit width is 8 bits and the first mantissa data whose bit width is 8 bits, the first lookup table to the third lookup table is configured as 8-input and 8-output, and then a total quantity of entries in the three lookup tables is 3×28-768. Obviously, the latter greatly saves the storage space required for the lookup table, the area and costs of a lookup table logic circuit, and speeds up a table lookup speed.

FIG. 5 is a structural block diagram of a hardware acceleration circuit according to another embodiment of this application.

Referring to FIG. 5, a hardware acceleration circuit includes an exponential function module 11, an adder 21, a first processing circuit 31, a second processing circuit 32, and a third processing circuit 33.

The exponential function module 11 is configured to obtain a plurality of exponential function values of a plurality of data elements in a data set.

The adder 21 is configured to obtain an addition operation result of the plurality of exponential function values.

In this embodiment, the addition operation result is a floating-point number. The adder 21 may perform an addition operation on the respective N4-bit exponential function values of all data elements according to the respective N4-bit exponential function values of all data elements inputted by the exponential function module 11, and output an N1-bit floating-point type addition operation result of the exponential function values of all data elements in the data set.

The first processing circuit 31 includes a third lookup table circuit 313 and a fourth lookup table circuit 314. The third lookup table circuit 313 is configured to obtain, based on a third lookup table, exponent data corresponding to the addition operation result. The fourth lookup table circuit 314 is configured to obtain, based on a fourth lookup table, mantissa data corresponding to the addition operation result.

The second processing circuit 32 is configured to perform preset processing on the exponent data and the mantissa data, to obtain the reciprocal of the addition operation result.

The third processing circuit 33 is configured to perform preset processing on an exponential function value of an i^{th} data element in the plurality of data elements and the reciprocal, to obtain a specific function value of the i^{th} data element.

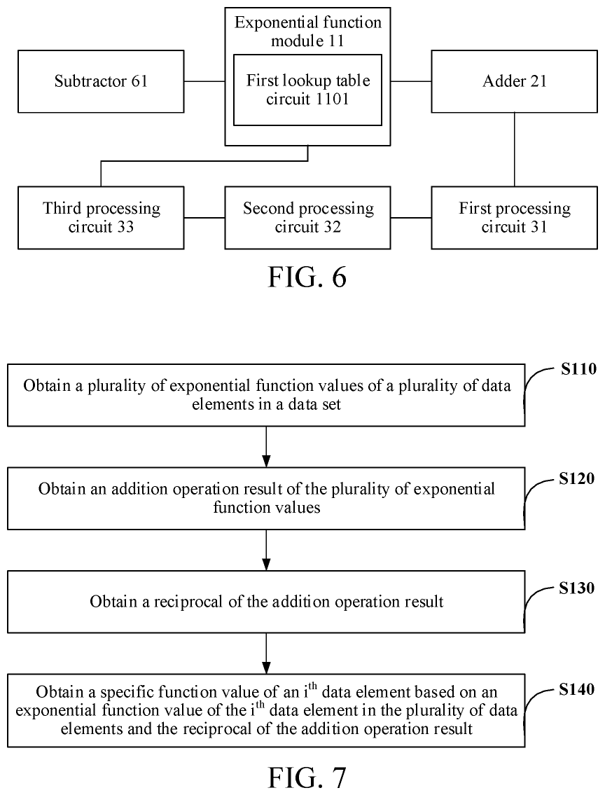

FIG. 6 is a structural block diagram of a hardware acceleration circuit according to another embodiment of this application.

Referring to FIG. 6, a hardware acceleration circuit includes a subtractor 61, an exponential function module 11, an adder 21, a first processing circuit 31, a second processing circuit 32, and a third processing circuit 33.

The subtractor 61 is configured to subtract a maximum value in a plurality of pieces of initial data from the plurality of pieces of initial data in an initial data set, to obtain the data set including the plurality of data elements.

The exponential function module 11 includes a first lookup table circuit 1101. The first lookup table circuit 1101 is configured to obtain, based on a first lookup table, the plurality of exponential function values corresponding to the plurality of data elements in the data set.

In a specific embodiment, the initial data set inputted into the hardware acceleration circuit is mathematically transformed, and it is assumed that the element xᵢ=xᵢ′-c. Each piece of initial data in the initial data set X and a maximum value in the initial data set are respectively calculated by the subtractor 61, and a data element corresponding to each initial data in the initial data set X is outputted, data elements corresponding to the initial data in the initial data set X form a data set, and a value of each data element in the data set is 0 or a negative number. The subtractor 61 performs a subtraction operation on a plurality of pieces of initial data in the initial data set, so that a value range of the data elements can be reduced, thereby making it convenient to implement the solution of this application by using data with a lower bit width and a corresponding hardware circuit. On the other hand, because the values of the data elements in the data set are negative numbers or 0, exponential function values of the data elements using e as the base may be normalized into a range of (0, 1].

To better understand a lookup procedure of this embodiment, Table 1 shows a specific example of the first lookup table, and the table is NO-bit input and N4-bit output, where N0 and N4 are both 8. A data element of the first lookup table may be an index value whose bit width is N0 bits, and output data may be an exponential function value whose bit width is N4 bits. For ease of understanding, each data in Table 1 is represented in a decimal format. It may be understood that, the first lookup table in the storage module stores only a true value of the exponential function value, and the first lookup table circuit is configured to implement a mapping relationship between the index value and the true value of the exponential function value. To better understand this application, data elements and normalized exponential function value are listed in a table together.

TABLE 1

| | | Normalized | Exponential |
|---|---|---|---|
| Index | Data | exponential function | function |
| value | element | value | value |
| 0 | 0 | 1.0 | 255 |
| 1 | −0.0390625 | 0.96169 | 246 |
| 2 | −0.078125 | 0.92485 | 237 |
| . . . | . . . | . . . | . . . |
| 254 | −0.960784 | 0.000047 | 0 |
| 255 | −10 | 0.000045 | 0 |

As shown in Table 1, data elements outputted by the subtractor 61 are negative numbers or 0, and a value range of the data elements is defined as [−10, 0]. To perform table lookup, the value range [−10, 0] is discretized into 256 (namely, 2N°) points shown by the column “data element”, an exponential function value of corresponding to each point is shown by the column “normalized exponential function value”, each data element point corresponds to an integer value in the range of [0, 255] shown in the column “index value”, each normalized exponential function value corresponds to an integer value in the range of [0, 255] shown in the column “exponential function value”, data in the column “exponential function value” is used as a true value and stored in the first lookup table of the storage module, and table lookup may be implemented through only an index value.

For implementations of the adder 21, the first processing circuit 31, the second processing circuit 32, and the third processing circuit 33, reference may be made to the foregoing embodiments. Details are not described herein again.

In a specific implementation, a data element may be a fixed-point integer whose bit width is 8 bits. Each exponential function value in the first lookup table is a fixed-point integer whose bit width is 8 bits. The addition operation result of the plurality of exponential function values is a fixed-point integer whose bit width is 32 bits. The first exponent data and first mantissa data, and the second exponent data and second mantissa data of the addition operation result are all fixed-point integers whose bit widths are 8 bits. In other words, the second lookup table, the third lookup table, and the fourth lookup table are all 8-input and 8-output. The multiplication operation result is a fixed-point integer whose bit width is 16 bits. The specific function value obtained by converting the multiplication operation result is a fixed-point integer whose bit width is 8 bits. That is to say, N0, N2, N3, N4, N5, and N7 are 8, N1 is 32, and N6 is 16.

It can be understood that, in some other embodiments, N0, N2, N3, N4, N5, and N7 may be other values. For example, a value range of N0, N2, N3, N4, N5, and N7 may be [1, 32]. In some specific examples, the value range may be [8, 12]. For example, N0, N2, N3, N4, N5, and N7 may alternatively be not equal. For example, values of N0 and N3 may be 9, 10, 11, or 12, and N2, N4, N5, and N7 are 8. Because a dynamic range of Softmax function values is very wide, the function is mostly implemented using a software module in the related technology. This embodiment of this application provides the solution basically based on an 8-bit hardware circuit and can effectively balance important indicators of the circuit such as costs, power consumption, bandwidth, performance, and data precision.

In this embodiment, in a process of obtaining the reciprocal of the addition operation result of the exponential function values of the data elements in a table lookup manner, the addition operation result is converted into a floating-point form to obtain exponent data and mantissa data of the addition operation result in the floating-point form. A plurality of lookup tables are respectively searched based on the exponent data and the mantissa data of the addition operation result, and the reciprocal of the addition operation result is outputted after several times of table lookup, so that a reciprocal with higher precision can be obtained.

Further, through the calculation process of the Softmax function, the addition operation result is converted into the floating-point form, and through several times of table lookup, the reciprocal of the addition operation result is obtained based on the data of the several times of table lookup. In addition, bit widths of input/output data of several times of table lookup is configured into a small range, storage resources occupied by the lookup table and the area of the lookup table circuit can be reduced, and the occupied bandwidth can be reduced. On the other hand, the table lookup speed and the fixed-point operation speed can be increased in a precision-allowed range, thereby further increasing the response speed of the circuit and reducing power consumption.

This application further provides an embodiment of a data processing acceleration method.

FIG. 7 is a schematic flowchart of a data processing acceleration method according to an embodiment of this application.

Referring to FIG. 7, the data processing acceleration method includes:

In step S110, a plurality of exponential function values of a plurality of data elements in a data set are obtained.

In step S120, an addition operation result of the plurality of exponential function values is obtained.

In step S130, a reciprocal of the addition operation result is obtained.

In step S140, a specific function value of an i^{th} data element is obtained based on an exponential function value of the i^{th} data element in the plurality of data elements and the reciprocal of the addition operation result.

The obtaining a reciprocal of the addition operation result in step S130 includes:

Step S130A: Convert the addition operation result into at least first data and second data.

Step S130B: Obtain the reciprocal of the addition operation result according to at least the first data and the second data, where the addition operation result is data whose length is N1 bits, the first data is data whose length is N2 bits, the second data is data whose length is N3 bits, and both N2 and N3 are less than N1.

It may be understood that, an addition operation result of exponential function values may be a result obtained by performing an addition operation directly on the exponential function values, or may be a result obtained by performing an addition operation on the exponential function values on which specific transformation is performed. For a situation of performing transformation, corresponding inverse transformation may be performed on a subsequently obtained data processing result based on a transformation type, or inverse transformation processing is not additionally performed. Similarly, various types of processing performed on other data should also be understood as including the foregoing two situations in a broad sense, but should not be limited to only processing performed on the data itself.

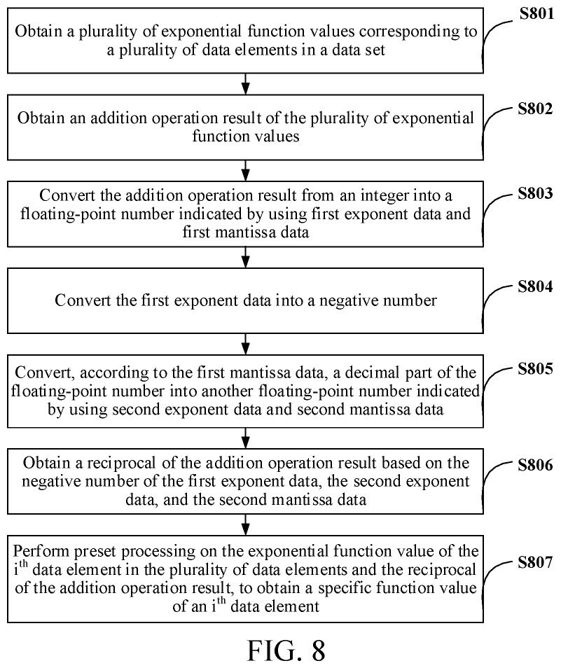

FIG. 8 is a schematic flowchart of a data processing acceleration method according to another embodiment of this application.

Referring to FIG. 8, the data processing acceleration method includes:

In step S801, a plurality of exponential function values corresponding to a plurality of data elements in a data set are obtained.

In an embodiment, in response to an index value of each data element in the data set, output an exponential function value corresponding to each data element, respective N4-bit exponential function values of all data elements in the data set are outputted by using a first lookup table module based on the first lookup table.

In step S802, an addition operation result of the plurality of exponential function values is obtained.

In an embodiment, the adder may perform an addition operation on the respective N4-bit exponential function values of all data elements, so that an N1-bit addition operation result that is of the exponential function values of all data elements in the data set and that is outputted by the adder is obtained, where the addition operation result may be an N1-bit fixed-point integer.

In step S803, the addition operation result is converted from the integer into a floating-point number indicated by using first exponent data and first mantissa data.

In an embodiment, the addition operation result outputted by the adder is an N1-bit integer represented in a fixed-point form. The integer-to-floating-point circuit may perform data conversion on the fixed-point integer, to obtain N2-bit first exponent data exp0 and N3-bit first mantissa data frac0 of the addition operation result.

In step S804, the first exponent data is converted into a negative number.

In an embodiment, the second lookup table circuit may respond to an index value of the first exponent data and output, based on the second lookup table, negative number exp1 corresponding to the first exponent data.

In step S805, a decimal part of the floating-point number is converted, according to the first mantissa data, into another floating-point number indicated by using second exponent data and second mantissa data.

In an embodiment, the third lookup table circuit may respond to an index value of the first mantissa data and output, based on the third lookup table, second exponent data exp2 corresponding to the first mantissa data. In an embodiment, the fourth lookup table circuit may respond to an index value of the first mantissa data and output, based on the fourth lookup table, second mantissa data frac1 corresponding to the first mantissa data.

In step S806, the reciprocal of the addition operation result is obtained based on the negative number of the first exponent data, the second exponent data, and the second mantissa data.

In an embodiment, a sum of the negative number of the first exponent data and the second exponent data is obtained through an exponent adder, and shift processing is performed on the second mantissa data by a shifter by using the sum as a shift parameter, to obtain an N5-bit reciprocal of the addition operation result.

In step S807, preset processing is performed on the exponential function value of the i^{th} data element in the plurality of data elements and the reciprocal of the addition operation result, to obtain a specific function value of an i^{th} data element.

In an embodiment, a multiplication circuit may perform a multiplication operation on an N4-bit exponential function value of the i^{th} data element in the plurality of data elements and an N5-bit reciprocal, to obtain an N6-bit multiplication operation result of the i^{th} data element. Further, the N6-bit multiplication operation result may be converted, for example, converted into an N7-bit result with a lower bit width. The converted result may be used as the Softmax function value of the i^{th} data element outputted by the hardware acceleration circuit. It may be understood that, converting the bit width of the multiplication operation result from N6 bits into N7 bits may be implemented by perform saturation (saturate) or integer conversion. The integer conversion includes, for example, rounding (round), ceiling, flooring, and rounding to zero.

In an embodiment, a length of the first exponent data and the second exponent data may be N2 bits, and a length of the first mantissa data and the second mantissa data may be N3 bits. Values of N2 and N3 may be in a range of [1, 32], and may be in a range of [8, 12] in some specific embodiments.

In this embodiment, the exponential function values of the data elements are obtained in a table lookup manner through a hardware lookup table circuit, and an addition operation result of the exponential function values is obtained through an adder. Floating point conversion is performed on the addition operation result, take the exponent part and mantissa part of the addition operation result in the floating-point form as input, a division operation on the addition operation result is implemented through the lookup table circuit, and the corresponding reciprocal of the addition operation result is obtained. In this way, complex exponential operations and reciprocal operations are avoided, which can increase a data processing speed in a Softmax function calculation procedure and obtain a Softmax function value more quickly. On the other hand, excessively large hardware circuit area and excessively high costs generated for implementing exponential operations and reciprocal operations are avoided.

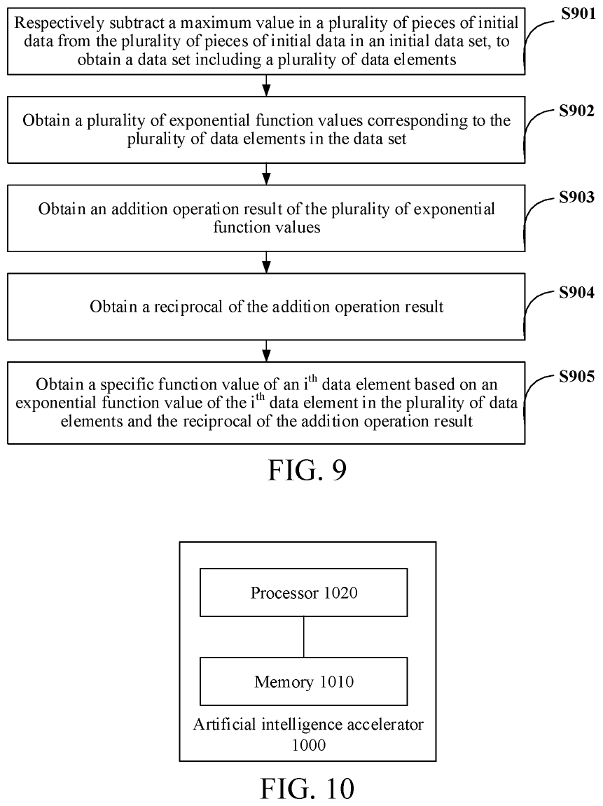

FIG. 9 is a schematic flowchart of a data processing acceleration method according to another embodiment of this application.

Referring to FIG. 9, the data processing acceleration method includes:

In step S901, a maximum value in a plurality of pieces of initial data is respectively subtracted from the plurality of pieces of initial data in an initial data set, to obtain the data set including the plurality of data elements.

In step S902, a plurality of exponential function values corresponding to a plurality of data elements in a data set are obtained.

In step S903, an addition operation result of the plurality of exponential function values is obtained.

In step S904, a reciprocal of the addition operation result is obtained.

In step S905, a specific function value of an i^{th} data element is obtained based on an exponential function value of the i^{th} data element in the plurality of data elements and the reciprocal of the addition operation result.

The addition operation result is a floating-point number.

The obtaining a reciprocal of the addition operation result in step S904 includes: converting the addition operation result into exponent data and mantissa data; and obtaining the reciprocal of the addition operation result according to at least the exponent data and the mantissa data.

A length of the addition operation result is N1 bits, a length of the exponent data is N2 bits, a length of the mantissa data is N3 bits, and both N2 and N3 are less than N1.

For related features of the data processing acceleration method in this embodiment of this application, reference may be made to related content in the embodiment of the foregoing hardware acceleration circuit. Details are not described again.

The data processing acceleration method according to the embodiments of this application is applicable to an artificial intelligence accelerator. FIG. 10 is a schematic structural diagram of an artificial intelligence accelerator according to an embodiment of this application.

Referring to FIG. 10, the artificial intelligence accelerator 1000 includes: a memory 1010 and a processor 1020.

The artificial intelligence accelerator 1020 may be a general-purpose processor such as a CPU (central processing unit), or may be an intelligence processing unit (IPU) configured to execute an artificial intelligence operation. The artificial intelligence operation may include a machine learning operation, a brain-like operation, and the like. The machine learning operation includes a neural network operation, a k-means operation, a support vector machine operation, and the like. The intelligence processing unit may include, for example, one of a GPU (graphics processing unit), a DLA (deep learning accelerator), an NPU (Neural-Network Processing Unit, neural network processing unit), a DSP (digital signal processor), a field-programmable gate array (field-programmable gate array, FPGA), and an application-specific integrated circuit (application-specific integrated circuit, ASIC) or a combination thereof. A specific type of the processor is not limited in this application.

The memory 1010 may include various types of storage units, for example, a system memory, a read-only memory (ROM), and a permanent storage apparatus. The ROM may store static data or instruction required by the processor 1020 or another module of a computer. The permanent storage apparatus may be a readable/writable storage apparatus. The permanent storage apparatus may be a non-volatile storage device that does not lose stored instructions and data even if the computer is powered off. In some implementations, a mass storage apparatus (for example, a magnetic disk, an optical disc, or a flash memory) is used as the permanent storage apparatus. In some other implementations, the permanent storage apparatus may be a removable storage device (for example, a floppy disk or an optical disc drive). The system memory may be a readable/writable storage device or a volatile readable/writable storage device, for example, a dynamic random access memory. The system memory may store some or all instructions and data required by the processor during running. Moreover, the memory 1010 may include any combination of computer-readable storage mediums, including various types of semiconductor storage chips (for example, a DRAM, an SRAM, an SDRAM, a flash memory, and a programmable read-only memory), and a magnetic disk and/or an optical disc may alternatively be used as the memory. In some implementations, the memory 1010 may include a readable and/or writable removable storage device, for example, a compact disc (CD), a read-only digital versatile disc (for example, a DVD-ROM or a double-layer DVD-ROM), a read-only Blu-ray disc, an ultra-density optical disc, a flash memory card (for example, an SD card, a min SD card, or a Micro-SD card), a magnetic floppy disk, and the like. The computer-readable storage medium does not include a carrier and an instantaneous electronic signal transmitted in a wireless or wired manner.

Executable code is stored on the memory 1010. When the executable code is processed by the processor 1020, the processor 1020 is enabled to execute part or all of the foregoing method.

In a possible implementation, the artificial intelligence accelerator may include a plurality of processors, and various assigned tasks may be independently run on each processor. The processor and the tasks run on the processor are not limited in this application.

It may be understood that, unless otherwise specified, functional units/modules in the embodiments of this application may be integrated into one unit/module, or each unit/module may exist alone physically, or two or more units/modules are integrated together. The foregoing integrated unit/module may be implemented in a form of hardware, or may be implemented in a form of a software program module.

If the integrated unit/module is implemented in a form of hardware, the hardware may be a digital circuit, an analog circuit, or the like. A physical implementation of the hardware structure includes but is not limited to a transistor, a memristor, or the like. Unless otherwise specified, the intelligence processing unit may be any proper hardware processor, for example, a CPU, a GPU, an FPGA, a DSP, or an ASIC. Unless otherwise specified, the storage module may be any proper magnetic disk storage medium or magnetic disk optical storage medium, for example, a resistive memory RRAM (Resistive Random Access Memory), a dynamic random access memory DRAM (Dynamic Random Access Memory), a static random access memory SRAM (Static Random Access Memory), an enhanced dynamic random access memory EDRAM (Enhanced Dynamic Random Access Memory), a high-bandwidth memory HBM (High-Bandwidth Memory), or a hybrid memory cube HMC (Hybrid Memory Cube).

When the integrated unit/module is implemented in the form of a software program module and sold or used as an independent product, the integrated module may be stored in a computer-readable memory. Based on such an understanding, the technical solutions of this application essentially, or the part contributing to the prior art, or all or some of the technical solutions may be implemented in a form of a software product. The computer software product is stored in a memory, and includes several instructions for instructing a computer device (which may be a personal computer, a server, or a network device) to perform all or some of the steps of the methods described in the embodiments of this application. The foregoing memory includes any medium that can store program code, such as a USB flash drive, a read-only memory (ROM, Read-Only Memory), a random access memory (RAM, Random Access Memory), a removable hard disk, a magnetic disk, or an optical disc.

In a possible implementation, an artificial intelligence chip is further disclosed, including the foregoing hardware acceleration circuit.

In a possible implementation, a card is further disclosed, including a storage device, an interface apparatus, a control device, and the foregoing artificial intelligence chip. The artificial intelligence chip is connected to each of the storage device, the control device, and the interface apparatus; the storage device is configured to store data; the interface apparatus is configured to implement data transmission between the artificial intelligence chip and an external device; and the control device is configured to monitor a status of the artificial intelligence chip.

In a possible implementation, an electronic device is disclosed, including the foregoing artificial intelligence chip. The electronic device includes a data processing apparatus, a robot, a computer, a printer, a scanner, a tablet computer, an intelligent terminal, a mobile phone, an event data recorder, a navigator, a sensor, a webcam, a server, a cloud server, a camera, a video camera, a projector, a watch, a headset, a portable storage, a wearable device, a transportation means, a household appliance, and/or a medical device. The transportation means includes an airplane, a steamship, and/or a vehicle; the household appliance includes a television set, an air conditioner, a microwave stove, a refrigerator, an electric cooker, a humidifier, a washing machine, an electric lamp, a gas stove, and a range hood; and the medical device includes a nuclear magnetic resonance spectrometer, a B-mode ultrasonic instrument, and/or an electrocardiography machine.

Moreover, the method according to this application may be further implemented as a computer program or computer program product, and the computer program or computer program product includes computer program code instructions used to execute some or all steps in the foregoing method of this application.

Alternatively, this application may be further implemented as a computer-readable storage medium (or a non-transient machine-readable storage medium or a machine-readable storage medium), on which executable code (or computer program or computer instruction code) is stored. When the executable code (or computer program or computer instruction code) is executed by a processor of an electronic device (or server or the like), the processor is enabled to execute some or all of the steps of the foregoing method according to this application.

The embodiments of this application are described above, and the foregoing descriptions are exemplary but not exhaustive and are not limited to the disclosed embodiments. Without departing from the scope and spirit of the described embodiments, many modifications and variations are apparent to a person of ordinary skill in the art. The selected terms used herein is intended to best explain the principles of the embodiments, practical applications, or improvements of technologies in the market, or to enable other persons of ordinary skill in the art to understand the embodiments disclosed herein.

What is claimed is:

1. A hardware acceleration circuit, comprising:
an exponential function module, configured to obtain a plurality of exponential function values of a plurality of data elements in a data set;
an adder, configured to obtain an addition operation result of the plurality of exponential function values;
a first processing circuit, configured to perform preset processing on the addition operation result, to process the addition operation result into at least first data and second data, wherein a length of the addition operation result is N1 bits, a length of the first data is N2 bits, a length of the second data is N3 bits, and both N2 and N3 are less than N1;
a second processing circuit, configured to perform preset processing on at least the first data and the second data, to obtain a reciprocal of the addition operation result; and
a third processing circuit, configured to perform preset processing on an exponential function value of an i^{th} data element in the plurality of data elements and the reciprocal, to obtain a specific function value of the i^{th} data element.

2. The hardware acceleration circuit according to claim 1, wherein
the addition operation result is an integer; and
the first processing circuit comprises: an integer-to-floating-point circuit, configured to convert the addition operation result from the integer into a floating-point number indicated by using first exponent data and first mantissa data.

3. The hardware acceleration circuit according to claim 2, wherein the second processing circuit comprises:
a first conversion circuit, configured to convert the first exponent data into a negative number;
a second conversion circuit, configured to convert, according to the first mantissa data, a decimal part of the floating-point number into another floating-point number indicated by using second exponent data and second mantissa data; and
a third conversion circuit, configured to obtain the reciprocal of the addition operation result according to the negative number, the second exponent data, and the second mantissa data.

4. The hardware acceleration circuit according to claim 3, wherein the third conversion circuit comprises:
an exponent adder, configured to obtain a sum of the negative number of the first exponent data and the second exponent data; and
a shifter, configured to perform shift processing on the second mantissa data by using the sum as a shift parameter.

5. The hardware acceleration circuit according to claim 3, wherein
the exponential function module comprises: a first lookup table circuit, configured to obtain, based on a first lookup table, a plurality of exponential function values corresponding to the plurality of data elements in the data set; and/or
the first conversion circuit comprises: a second lookup table circuit, configured to obtain, based on a second lookup table, a negative number corresponding to the first exponent data; and/or
the second conversion circuit comprises: a third lookup table circuit, configured to obtain, based on a third lookup table, second exponent data corresponding to the first mantissa data; and a fourth lookup table circuit, configured to obtain, based on a fourth lookup table, second mantissa data corresponding to the first mantissa data.

6. The hardware acceleration circuit according to claim 3, wherein
a length of the first exponent data and a length of the second exponent data are N2 bits, and a length of the first mantissa data and a length of the second mantissa data are N3 bits; and
values of N2 and N3 are in a range of [1, 32].

7. The hardware acceleration circuit according to claim 5, wherein the hardware acceleration circuit comprises at least two lookup table circuits in the first lookup table circuit to the fourth lookup table circuit, wherein
the at least two lookup table circuits each have a basic lookup table circuit unit; or
the at least two lookup table circuits share a basic lookup table circuit unit.

8. The hardware acceleration circuit according to claim 1, wherein
the addition operation result is a floating-point number;
the first processing circuit comprises: a third lookup table circuit, configured to obtain, based on a third lookup table, exponent data corresponding to the addition operation result; and a fourth lookup table circuit, configured to obtain, based on a fourth lookup table, mantissa data corresponding to the addition operation result;
the second processing circuit is configured to perform preset processing on the exponent data and the mantissa data, to obtain the reciprocal of the addition operation result; and
the third processing circuit is configured to perform preset processing on the exponential function value of the i^{th} data element in the plurality of data elements and the reciprocal, to obtain the specific function value of the i^{th} data element.

9. The hardware acceleration circuit according to claim 1, wherein
the hardware acceleration circuit further comprises: a subtractor, configured to subtract a maximum value in a plurality of pieces of initial data from the plurality of pieces of initial data in an initial data set, to obtain the data set comprising the plurality of data elements; and
a third processing circuit comprises: a multiplier, configured to perform a multiplication operation on the exponential function value of the i^{th} data element in the plurality of data elements and the reciprocal, to output a Softmax function value of the i^{th} data element.

10. An artificial intelligence chip, comprising the hardware acceleration circuit according to claim 1.

11. A data processing acceleration method, applied to an artificial intelligence accelerator, the method comprising:
obtaining a plurality of exponential function values of a plurality of data elements in a data set;
obtaining an addition operation result of the plurality of exponential function values;
obtaining a reciprocal of the addition operation result; and
obtaining a specific function value of an i^{th} data element based on an exponential function value of the i^{th} data element in the plurality of data elements and the reciprocal,
wherein the reciprocal of the addition operation result is obtained by:
processing the addition operation result into at least first data and second data; and
obtaining the reciprocal of the addition operation result according to at least the first data and the second data,
wherein a length of the addition operation result is N1 bits, a length of the first data is N2 bits, a length of the second data is N3 bits, and both N2 and N3 are less than N1.

12. The method according to claim 11, wherein
the addition operation result is a floating-point number; and
the processing the addition operation result into at least first data and second data comprises: converting the addition operation result into exponent data and mantissa data.

13. The method according to claim 11, wherein
the addition operation result is an integer;
the addition operation result is processed into at least the first data and the second data by: converting the addition operation result from the integer into a floating-point number indicated by using first exponent data and first mantissa data; and converting, according to the first mantissa data, a decimal part of the floating-point number into another floating-point number indicated by using second exponent data and second mantissa data; and
the reciprocal of the addition operation result is obtained according to at least the first data and the second data by: obtaining the reciprocal corresponding to the addition operation result according to at least the first exponent data, the second exponent data, and the second mantissa data.

14. The method according to claim 13, wherein the reciprocal corresponding to the addition operation result is obtained according to at least the first exponent data, the second exponent data, and the second mantissa data by:
obtaining a negative number of the first exponent data;
obtaining a sum of the negative number of the first exponent data and the second exponent data; and
performing shift processing on the second mantissa data by using the sum as a shift parameter.

15. The method according to claim 14, wherein
the plurality of exponential function values of the plurality of data elements in the data set are obtained by: obtaining, based on a first lookup table, the plurality of exponential function values corresponding to the plurality of data elements in the data set;
and/or the negative number of the first exponent data is obtained by: obtaining, based on a second lookup table, the negative number corresponding to the first exponent data.

16. The method according to claim 13, wherein the second exponent data and the second mantissa data are obtained according to the first mantissa data by:
obtaining, based on a third lookup table, the second exponent data corresponding to the first mantissa data; and
obtaining, based on a fourth lookup table, the second mantissa data corresponding to the first mantissa data.

17. The method according to claim 13, wherein
a length of the first exponent data and a length of the second exponent data are N2 bits, and a length of the first mantissa data and a length of the second mantissa data are N3 bits; and
values of N2 and N3 are in a range of [1, 32].

18. The method according to claim 11, wherein
before the obtaining a plurality of exponential function values of a plurality of data elements in a data set, the method further comprises: respectively subtracting a maximum value in a plurality of pieces of initial data from the plurality of pieces of initial data in an initial data set, to obtain the data set comprising the plurality of data elements.

19. The method according to claim 11, wherein the specific function value of the i^{th} data element is obtained based on the exponential function value of the i^{th} data element in the plurality of data elements and the reciprocal by:
performing a multiplication operation on the exponential function value of the i^{th} data element in the plurality of data elements and the reciprocal, to obtain a Softmax function value of the i^{th} data element.

20. The method according to claim 11, wherein the method is performed to implement a Softmax function layer of a neural network, and the neural network is configured to classify to-be-processed data, wherein
the to-be-processed data comprises at least one of voice data, text data, and image data.

21. An artificial intelligence accelerator, comprising:
a processor; and
a memory, storing executable code, the executable code, when executed by the processor, causing the processor to perform the method according to claim 11.
